(19) United States
(12) Patent Application Publication
(10) Pub. No.: US 2007/0044799 A1
(43) Pub. Date: Mar. 1, 2007

(54) Modular oxygen regulator system and respiratory treatment system

(76) Inventors: Bernie F. Hete, Kittanning, PA (US); Patrick W. Truitt, Mars, PA (US)

Correspondence Address: MICHAEL W. HAAS;RESPIRONICS, INC., 1010 MURRY RIDGE LANE, MURRYSVILLE, PA, 15668, US

(21) Appl. No.: 11/480,595

(22) Filed: Jul. 3, 2006

Related U.S. Application Data
(60) Provisional application No. 60/697,744, filed on Jul. 8, 2005.

(51) Int. Cl. A62B 7/00

(52) U.S. Cl. 128/205.11

(57) ABSTRACT

A gas delivery system that generates a pressurized flow of breathable gas for delivery to a patient. The system includes a primary gas delivery system for delivering a flow of pressured gas to the airway of a patient and supplemental gas delivery system. The supplemental gas delivery system is in the form of a modular gas regulator assembly that regulates the flow of supplemental gas from a gas source to the primary gas delivery system so that supplemental gas is delivered to the patient concomitant with the pressurized flow of breathable gas. The system allows the user to selectively control the gas concentration level of the supplemental gas, such as oxygen, helium, nitrogen or any combination thereof, and the pressurized flow of breathable gas delivered to the patient concomitantly.

### CROSS-REFERENCE TO RELATED APPLICATIONS

This application claims priority under 35 U.S.C. §119(e) from provisional U.S. patent application No. 60/697,744 filed Jul. 8, 2005, the contents of which are incorporated herein by reference.

### BACKGROUND OF THE INVENTION

1. Field of the Invention

The invention relates to respiratory treatment systems, and, in particular, to systems that includes a modular assembly that allows the introduction of a supplemental gas, such as oxygen, helium, nitrogen, or any combination there, with a primary flow of gas being delivered to a patient.

2. Description of the Related Art

Ventilators, pressure support systems, and the like (collectively “ventilators”) are commonly used for delivering a pressurized flow of breathable gas to a patient in order to treat a variety of medical conditions, including sleep disordered breathing and the like. Some conventional ventilators are capable of controlling an oxygen concentration level of the gas delivered to the patient by combining supplemental oxygen with the pressurized flow of breathable gas. However, ventilators that provide this functionality are typically expensive.

In an attempt to provide an inexpensive system that elevates the oxygen concentration level of gas delivered to the patient, it is known to introduce a flow of supplemental oxygen into the gas delivered to the patient by the ventilator. Thus, a ventilator without the capability of combining the breathable gas with supplemental oxygen may be used in conjunction with a supply of supplemental oxygen that is introduce into the patient circuit at a location downstream from the ventilator, such as at an entrainment port or at the patient interface, which is the device that attaches the patient circuit to the airway of the patient. While these conventional methods for providing supplemental oxygen to the breathable gas downstream from the ventilator elevate the oxygen concentration level of the breathable gas, they do not enable the oxygen concentration level to be accurately controlled.

### SUMMARY OF THE INVENTION

Accordingly, it is an object of the present invention to provide a supplemental gas regulator assembly that overcomes the shortcomings of conventional gas delivery techniques. This object is achieved according to one embodiment of the present invention by providing a modular gas regulator assembly that selectively controls a gas concentration delivered to a patient. The a flow of supplemental gas, such as oxygen or heliox (i.e., a helium-oxygen mixture), is delivered to the patient by the modular gas regulator concomitantly with a pressurized flow of breathable gas generated by a gas delivery system, the gas delivery system being controlled by a delivery system processor in the modular regulator.

In an exemplary embodiment, the modular gas regulator assembly comprises a control interface, an gas flow regulator, and a regulator processor. The control interface enables selection of a gas concentration level setpoint. The gas flow regulator regulates a flow rate of the supplemental gas from a gas source. The regulator processor controls the gas flow regulator such that the supplemental gas from the gas source and the pressurized flow of breathable gas delivered to the patient have an gas mixture concentration level that is substantially equal to the gas mixture concentration level setpoint. The regulator processor is independent from the delivery system processor.

Another aspect of the invention relates to a patient treatment system comprising a gas delivery system, a delivery system processor, a modular gas regulator assembly, and a regulator processor. The gas delivery system generates a pressurized flow of breathable gas for delivery to a patient. The delivery system processor is associated with the gas delivery system, and controls the gas delivery system in generating the pressurized flow of breathable gas. The modular gas regulator assembly regulates a flow of supplemental gas, such as oxygen or helium, from a gas source. The supplemental gas is delivered to the patient concomitant with the pressurized flow of breathable gas to selectively control an gas concentration level of the supplemental gas and the pressurized flow of breathable gas delivered to the patient concomitantly. The regulator processor is associated with the modular gas regulator assembly, and regulates the flow of the supplemental gas. The regulator processor is independent from the delivery system processor.

Another aspect of the invention relates to a patient treatment system comprising a first housing, a pressure generator, a first processor, a second housing independent from the first housing, a gas flow regulator, and a second processor. The pressure generator is contained within the first housing, and generates a pressurized flow of breathable gas for delivery to a patient. The first processor is contained within the first housing, and controls the pressure generator. The gas flow regulator is contained in the second housing, and regulates a flow rate of supplemental gas, such as oxygen or heliox, from a supplemental gas supply for delivery to the patient concomitantly with the pressurized flow of breathable gas. The second processor is contained within the second housing, and controls the gas flow regulator.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a patient treatment system, in accordance with one embodiment of the invention;

FIG. 2 illustrates a gas delivery system according to one embodiment of the invention;

FIG. 3 illustrates an alternative configuration of the gas delivery system, in accordance with one embodiment of the invention;

FIG. 4 illustrates a gas regulator assembly according to one embodiment of the invention; and

FIG. 5 illustrates an alternative embodiment of the gas regulator assembly, in accordance with one embodiment of the invention.

### DETAILED DESCRIPTION OF THE EXEMPLARY EMBODIMENTS

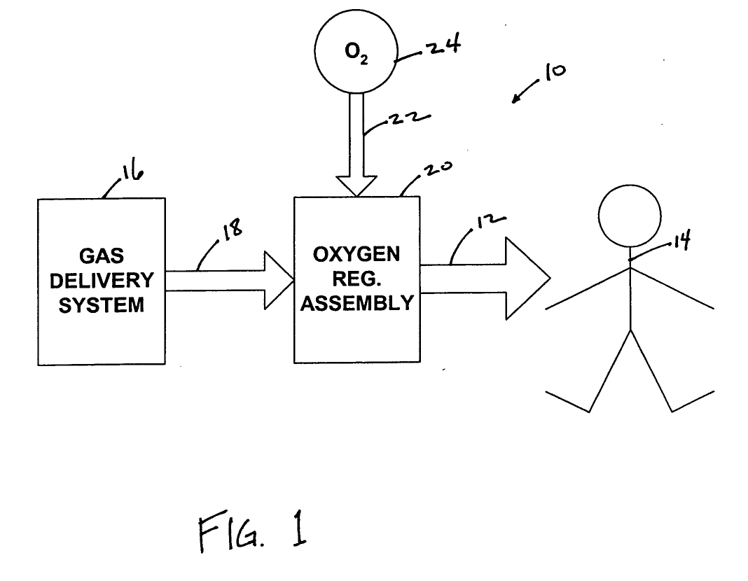

FIG. 1 illustrates a patient treatment system 10 that delivers a flow of gas 12 at a selectably controllable gas concentration level to a patient 14, according to one embodiment of the invention. The patient treatment system 10 includes a gas delivery system 16 that generates a pressurized flow of breathable gas 18, which is also referred to as a primary gas flow. The gas delivery system 16 may include a non-invasive pressure support ventilator (NPPV) or pressure support system that generates the pressurized flow of breathable gas 18 according to a conventional mode of ventilation, such as, for example, Continuous Positive Airway Pressure (CPAP), bi-level positive airway pressure (bi-PAP), auto-titration, proportional assist ventilation (PAV), C-Flex, Bi-Flex, PPAP or another conventional mode of invasive or non-invasive ventilation.

Patient treatment system 10 includes a modular oxygen regulator assembly 20 that is implemented as a stand alone device capable of regulating a flow of a supplemental gas, such as oxygen 22, from an oxygen source 24 for delivery to patient 14 concomitantly with the pressurized or primary flow of breathable gas 18 such that the combination of the concomitantly delivered flow of pressurized gas 18 from gas delivery system 16 and supplemental oxygen 22 forms oxygenated gas 12. Oxygen source 24 can be any source of oxygen, such as compressed oxygen from a tank, oxygen provided by an oxygen concentrator or a store of liquid oxygen, or oxygen generated in any manner.

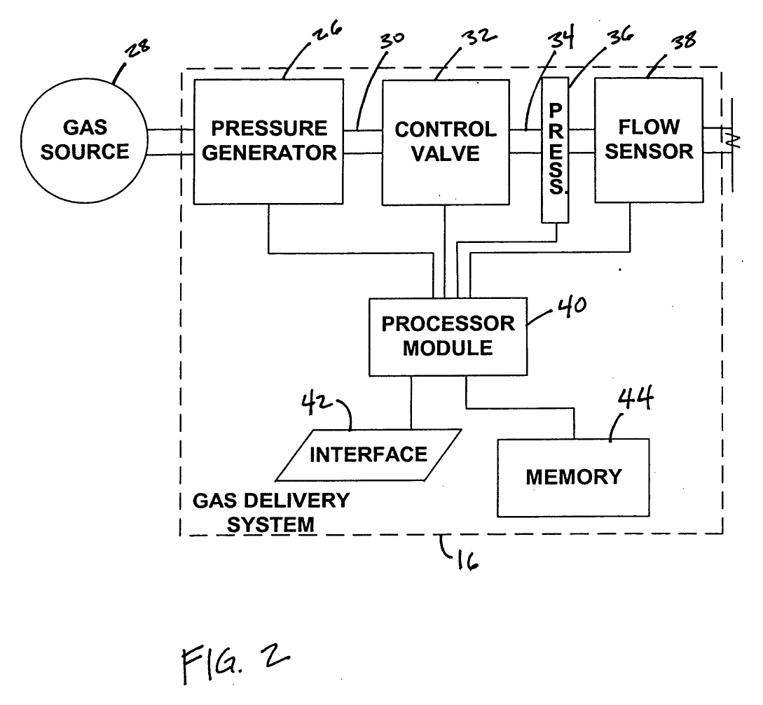

FIG. 2 schematically illustrates an exemplary embodiment of gas delivery system 16 according to the present invention. In an exemplary embodiment of the present invention, the gas delivery system 16 is capable of providing and automatically controlling the pressure of breathable gas delivered to a patient according to a predetermined mode of ventilation. Gas delivery system 16 includes a pressure generator 26 that receives a supply of breathable gas from a breathable gas source 28, and elevates the pressure of that gas for delivery to the airway of a patient. Pressure generator 26 may include any device, such as a blower, piston, or bellows that is capable of elevating the pressure of the received breathable gas from source 28 for delivery to a patient. In one embodiment, gas source 28 is simply atmospheric air drawn into the system by pressure generator 26. In another embodiment, gas source 28 constitutes a tank of pressurized gas connected with pressure generator 26. In one embodiment, the tank of gas is a tank of air.

The present invention also contemplates that a separate gas source 28 need not be used, but instead the pressure generator 26 can be defined by a canister or tank of pressurized gas, with the pressure delivered to the patient being controlled by a pressure regulator. In addition, while the embodiment of FIG. 2 illustrates a separate gas source 28, the present invention contemplates that gas source 28 can be considered to be part of the gas delivery system 16. In addition, in another embodiment, gas source 28 can be provided in the same housing as the rest of the gas delivery system 16. In yet another embodiment, gas source 28 is not only considered part of the gas delivery system 16, but also provides the pressurized flow of breathable gas so as to constitute a pressure generator and thus eliminates the need for the separate pressure generator 26.

In one embodiment of the present invention, pressure generator 26 is a blower that is driven at a constant speed during the course of the pressure support treatment to produce a constant pressure at its output 30.

In the illustrated embodiment, gas delivery system 16 includes a control valve 32. The breathable gas is delivered to control valve 32, with an elevated pressure, downstream of pressure generator 26. Control valve 32, either alone or in combination with pressure generator 26, controls the final pressure or flow of gas 34 exiting the pressure/flow generating system, which, in this embodiment includes pressure generator 26 and control valve 32. Examples of a suitable control valve 32 include at least one valve, such as sleeve or poppet valve, that exhausts gas from the patient circuit as a method of controlling the pressure in the patient circuit. U.S. Pat. No. 5,694,923, the contents of which are incorporated herein by reference, teaches a dual poppet valve system suitable for use as control valve 32 that exhausts gas to atmosphere and restricts the flow of gas from the pressure generator 26 to the patient. Other suitable pressure/flow controllers are believed to be well known to those skilled in the art. For example, U.S. Pat. No. 6,615,831, the contents of which are incorporated herein by reference, teaches a sleeve valve suitable for use as the control valve of the present invention.

In embodiments in which pressure generator 26 is a blower that operates at all times at one speed, control valve 32 alone controls the final pressure for breathable gas 34 output from control valve 32 for delivery to a patient, which is typically accomplished via a flexible conduit. However, the present invention also contemplates controlling the operating speed of pressure generator 26 in combination with control valve 32 to control the final pressure and flow rate of the breathable gas delivered to the patient. For example, a pressure or flow rate close to the desired pressure or flow rate can be set by establishing an appropriate operating speed for pressure generator 26 along with control valve 32 so that the two, operating together, determine the final pressure for the breathable gas 34.

The pressure of the pressurized flow of breathable gas is measured by a pressure sensor 36. In the embodiment of FIG. 2, pressure sensor 36 is a single sensor unit disposed downstream of pressure generator 26 and control valve 32. However, in other embodiments, pressure sensor 36 may include a single sensor unit disposed elsewhere, such as at an inlet of control valve 32, or at a location downstream from gas delivery system 16. Alternatively, pressure sensor 36 may include a plurality of sensor units disposed at various locations within gas delivery system 16. Pressure sensor 36 may include any device, transducer, or devices, capable of measuring the pressure of the pressurized flow of breathable gas generated by gas delivery system 16.

In the embodiment of FIG. 2, gas delivery system 16 includes a flow sensor 38. The pressurized flow of breathable gas 34 output from control valve 32 is delivered to flow sensor 38, which measures the instantaneous volume (V) of gas delivered to the patient, and/or the instantaneous flow rate (V′) of such gas to the patient, or both. Flow sensor 38 may include any device suitable for measuring these parameters, such as a spirometer, pneumotach, variable orifice transducer, or other conventional flow transducer. It is to be understood that the flow can be determined by monitoring the operation of pressure generator 26, such as the voltage, current, or power provided to the blower, its operating speed, etc., all of which vary with the pressure or flow in the patient circuit. The present invention also contemplates monitoring the operation of control valve 32, such as the position of the valve, as a means for determining the flow of gas in the patient circuit, for it is known that the position of the valve in a feedback controlled pressure generating module corresponds to the flow of gas in the patient circuit. Thus, flow sensor 38 can be incorporated into pressure generator 26, control valve 32, or both.

As shown, gas delivery system 16 includes a delivery system processor 40 that controls the various operating aspects of gas delivery system 16. For example, the output of flow sensor 38 and pressure sensor 36 are provided to delivery system processor 40 for processing, if needed, to determine the pressure of the breathable gas, the instantaneous volume (V) of breathable gas, and/or the instantaneous flow rate (V′) of the breathable gas. In some instances, the delivery system processor 40 determines the instantaneous volume by integrating the measured flow rate measured by flow sensor 38. Because, in one embodiment, the flow sensor 38 may be located relatively far from the location at which the breathable gas is delivered to the patient, in order to determine the actual flow rate of gas to the patient (or the actuation flow rate of gas from the patient—which is considered a negative flow), delivery system processor 40 receives the output from flow sensor 38 as an estimated flow. The delivery system processor 40 processes this estimated flow information, for example, by performing leak estimation, to determine the actual flow at the patient's airway, as is known to those skilled in the art.

A delivery system control interface 42 provides data and commands to delivery system processor 40 of gas delivery system 16. Delivery system control interface 42 may include any device suitable to provide information and/or commands to delivery system processor 40 via a hardwire or wireless connection. Typical examples of delivery system control interface 42 may include a keypad, keyboard, touch pad, mouse, microphone, switches, button, dials, or any other devices that allow a user to input information to the gas delivery system 16. Interface 42 can also include hardwired or wireless techniques for communicating information and/or commands with processor 40, such as a serial port, parallel port, USB, port, RS-232 port, smart card terminal, modem port, etc.

Delivery system processor 40 controls pressure generator 26 and the actuation of control valve 32, thereby controlling the pressure of the pressurized flow of breathable gas generated by the gas delivery system 16. In one embodiment, delivery system processor 40 comprises a processor that is suitably programmed with the necessary algorithm or algorithms to calculate the pressure to be applied to the patient according to one of any one of various modes of ventilation. In addition, the processor 40 may be capable of controlling pressure generator 26 and/or control valve 32 based on data received from pressure sensor 36 and/or flow sensor 38 to apply the calculated pressure to the breathable gas within gas delivery system 16. In one embodiment of the present invention, the gas delivery system 16 includes a memory 44 associated with delivery system processor 40 for storing the programming necessary to perform any of a plurality of modes of ventilation, depending on which mode of ventilation is selected by the caregiver or patient using delivery system control interface 42. Memory 44 may also be capable of storing data regarding the operation of the gas delivery system 16, input commands, alarm thresholds, as well as any other information pertinent to the operation of the gas delivery system 16, such as measured values of gas flow, volume, pressure, device usage, operating temperatures, and motor speed.

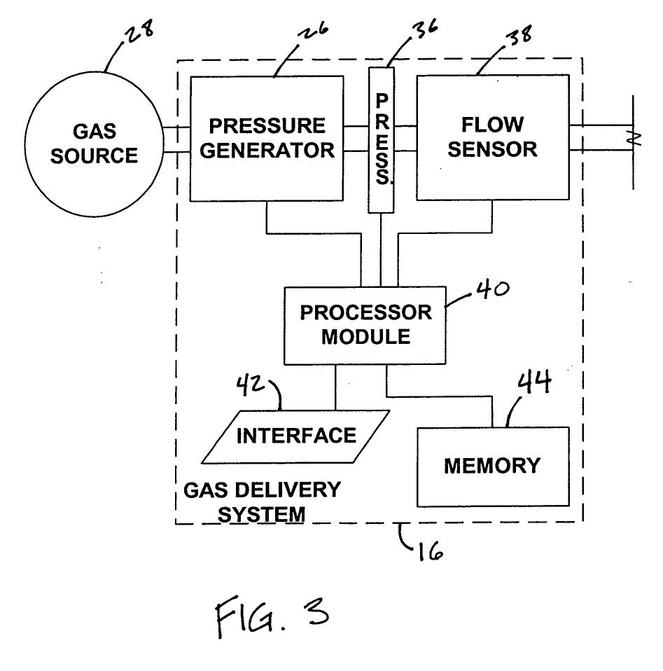

An alternative embodiment of gas delivery system 16 is discussed below with reference to FIG. 3. Unlike the embodiment of FIG. 2, the final pressure of the breathable gas is not controlled by a control valve, either alone or in combination with pressure generator 26. Instead, gas delivery system 16 controls the pressure of breathable gas based only on the output of a pressure generator 26. That is, delivery system processor 40 controls the pressure of breathable gas delivered to the patient by controlling the motor speed of pressure generator 26. Thus, control valve 32 is omitted. In one embodiment, pressure generator 26 is a blower. The present invention contemplates implementing the pressure of the breathable gas as measured by pressure sensor 36 and a speed monitor for the blower motor to provide feedback data to delivery system processor 40 for controlling the operation of pressure generator 26.

The present invention further contemplates that gas delivery system 16 or 16′ and related components can include other conventional devices and components, such as a humidifier, heater, bacteria filter, temperature sensor, humidity sensor, and a gas sensor (e.g., a capnometer), that filter, measure, monitor, and analyze the flow of gas to or from the patient.

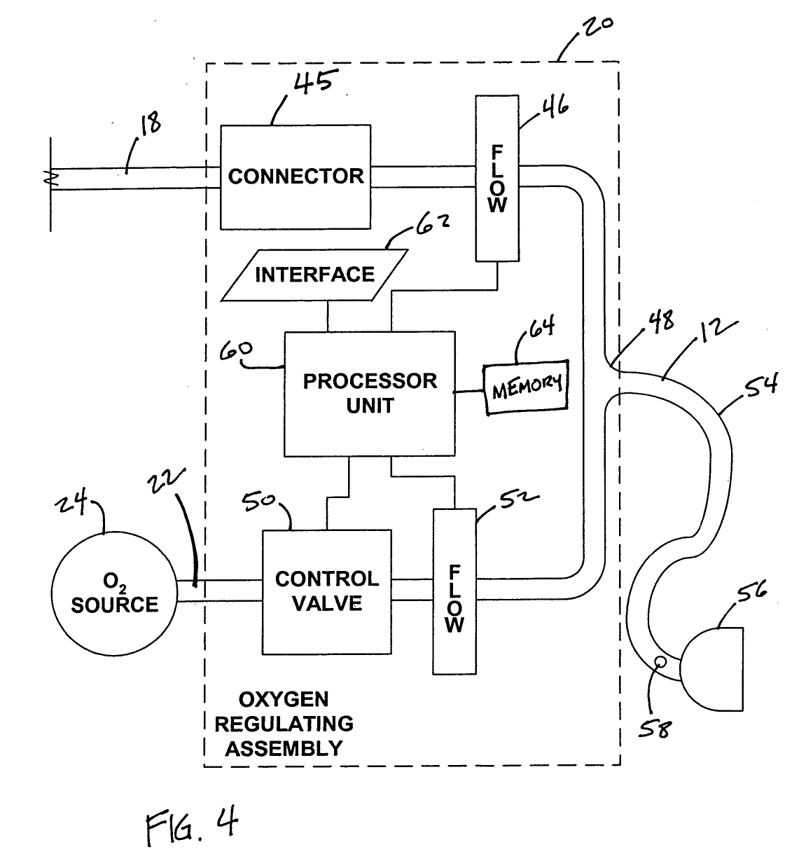

FIG. 4 schematically illustrates further details of the modular oxygen regulator assembly 20. At a connector 45 that is removably coupled with gas delivery system 16, oxygen regulator assembly 20 receives the pressurized flow of breathable gas 18 from gas delivery system 16. In some instances, connector 45 may be coupled to gas delivery system 16 at a housing associated with gas delivery system 16. Alternatively, connector 45 may be coupled to a patient circuit, or other conduit, associated with gas delivery system 16. In an exemplary embodiment, the oxygen regulator assembly is disposed at a location where the patient circuit is configured to receive a conventional patient interface assembly, such as a mask. Of course, a short patient circuit or conduit can be used to couple the outlet of the gas delivery system to the inlet (connector 45) of the oxygen regulator assembly.

The flow of the pressurized flow of breathable gas is measured by a first flow sensor 46 associated with oxygen regulator assembly 20. First flow sensor 46 may be disposed at any location upstream from a junction 48, at which the pressurized flow of breathable gas is combined with supplemental oxygen from oxygen source 24. Although first flow sensor 46 is illustrated in FIG. 4 as a separate flow sensor located at oxygen regulator assembly 20, it should be appreciated that in another embodiment the flow of the pressurized flow of breathable gas may be obtained by oxygen regulator assembly 20 from a flow sensor not disposed at oxygen regulator assembly 20. For example, oxygen regulator assembly 20 may be operatively linked with gas delivery system 16, and may receive data related to the flow of the pressurized flow of breathable gas as measured by flow sensor 38 from gas delivery system 16.

As shown in FIG. 4, the flow of the supplemental oxygen from oxygen source 24 is controlled by an oxygen control valve 50. Oxygen control valve 50 may include a connector for coupling oxygen regulator assembly 20 to oxygen source 24, a filter/regulator for filtering and adjusting the supply pressure of the supplemental oxygen, and/or valving for controlling the flow of the supplemental oxygen.

The valving of oxygen control valve 50 may include one or more solenoid driven control valves capable providing a desired amount of flow. For instance, control valve 50 may include a plurality of small, off-the-shelf, normally-closed, spring-return poppet valves (driven by a solenoid) such as those manufactured by Pneutronics, Inc. For example, each valve may provide approximately 35 L/min. of flow at 35 psi drive pressure, and, in one embodiment, three valves may be used. The three valves may be wired such that driving control for the valves can be applied simultaneously to each valve. The aforementioned valves manufactured by Pneutronics are designed to open at a precise current level, thereby circumventing the problem of control non-linearities associated with an arrangement in which all valves do not open simultaneously.

In one embodiment, the filter/regulator of oxygen control valve 50 may be configured and arranged to preclude the type of accumulation of particles in oxygen control valve 50 that would cause the valving to stick open and permit oxygen leakage.

The filter/regulator may further be configured and arranged to throttle down the drive pressure of the supplemental oxygen to a desirably low level, such as 50 psi, to reduce the variability of inadvertent design variations (e.g., manufacturing defects) that could otherwise have an effect on the supply pressure or controllability of the valving. For example, the filter/regulator may include a “bowl”-type filter/regulator manufactured by Parker-Hannifin.

In the embodiment of FIG. 4, a flow rate of the supplemental oxygen is measured by a second flow sensor 52 associated with oxygen regulator assembly 20.

Second flow sensor 52 is disposed downstream from oxygen control valve 50 in order to monitor the flow rate of the supplemental oxygen being directed to junction 48 for combination with the pressurized flow of breathable gas.

The combination of the pressurized flow of breathable gas 18 and the supplemental oxygen 24 at junction 48 forms a flow of oxygenated gas that is delivered to the patient via a patient circuit 54, which is typically a single flexible conduit that carries the flow of breathing gas to a patient interface assembly 56. In the illustrated embodiment, the patient interface assembly 56 and/or patient circuit 54 includes a suitable exhaust port 58 for exhausting gas from these components to ambient atmosphere. Exhaust port 58 is preferably a passive exhaust port in the form of a continuously open port that imposes a flow restriction on the exhaust gas to permit control of the pressure of gas within patient interface assembly 56. It is to be understood, however, that exhaust port 58 can be an active exhaust port that assumes different configurations to control the exhaust rate. Examples of suitable exhaust ports are taught, for example, in U.S. Pat. Nos. 5,685,296 and 5,937,855 hereby incorporated by reference.

The present invention contemplates that in an embodiment (not illustrated), the patient circuit 54 can be a two-limb circuit, which is common in conventional ventilators. In a two-limb circuit, the first limb, like patient circuit 54, delivers oxygenated gas to the patient, except that it lacks an exhaust port. Instead, a second limb carries the exhaust gases from the patient to ambient atmosphere. Typically, an active exhaust port in the second limb under the control of a controller (e.g. regulator processor 60) provides the desired level of positive end expiratory pressure (PEEP) to the patient.

As shown, oxygen regulator assembly 20 includes a regulator processor 60 that controls the various operating aspects of oxygen regulator assembly 20. For example, the output of first flow sensor 46 and second flow sensor 52 are provided to regulator processor 60 for processing, if needed, to determine and/or regulate the flow rate (V′) of the pressurized flow of the breathable gas and the supplemental oxygen.

A regulator control interface 62 provides data and commands to regulator processor 60 of oxygen regulator assembly 20. Regulator control interface 62, may include any device suitable to provide information and/or commands to regulator processor 60 via a hardwire or wireless connection. Typical examples of regulator control interface 62 may include a keypad, keyboard, touch pad, mouse, microphone, switches, button, dials, or any other devices that allow a user to input information to the oxygen regulator assembly 20. Regulator control interface 62 can also include hardwired or wireless techniques for communicating information and/or commands with processor 60, such as a serial port, parallel port, USB, port, RS-232 port, smart card terminal, modem port, etc.

In one embodiment of the invention, the patient, or another individual, enters an oxygen concentration level setpoint using regulator control interface 62. Based on the oxygen concentration level setpoint entered at regulator control interface 62, regulator processor 60 controls the flow of supplemental oxygen such that the oxygen concentration level of the oxygenated gas delivered to the patient is substantially equal to the oxygen concentration setpoint. More particularly, regulator processor 60 controls the actuation of oxygen control valve 50, thereby controlling the flow rate of the supplemental oxygen delivered from oxygen source 24 to junction 48.

In one embodiment of the present invention, oxygen regulator assembly 20 includes a memory 64 associated with regulator processor 60 for storing the programming necessary to perform these and other functionalities. Memory 64 may also be capable of storing data regarding the operation of the oxygen regulator assembly 20, such as input commands, alarm thresholds, as well as any other information pertinent to the operation of the oxygen regulator assembly 20, such as measured values of gas flow, volume, pressure, device usage, and operating temperatures.

According to one embodiment of the invention, regulator processor 60 comprises a processor that is suitably programmed with the necessary algorithm or algorithms to calculate the flow rates of the breathable gas and the supplemental oxygen, and the oxygen concentration level of the oxygenated gas that is delivered to the patient, and is capable of controlling oxygen control valve 50 based on data received from first flow sensor 46 and/or second flow sensor 52 to supply the supplemental oxygen at a flow rate that will ensure that the oxygen concentration level of the oxygenated gas is maintained substantially equal to the oxygen concentration level setpoint.

For example, regulator processor 60 may determine an oxygen flow rate setpoint that represents the flow rate of the supplemental oxygen that will ensure that the oxygen concentration level of the oxygenated gas delivered to the patient will be substantially equal to the oxygen concentration level setpoint according to the following equation:

$${Q}_{app} = {Q}_{bg} ( \frac{{Φ}_{set} - {Φ}_{bg}}{1 - {Φ}_{set}} ) , \qquad ( 1 )$$

where Qₐₚₚ is the oxygen flow rate setpoint, Q_{bg} is the measured flow rate of the breathable gas as measured by first flow sensor 46, Φ_{bg} is the oxygen concentration level of the breathable gas (e.g., 0.79 for ambient atmosphere), and Φₛₑₜ is the oxygen concentration level setpoint entered at regulator control interface 62. Regulator processor 60 then controls oxygen control valve 50 such that the flow rate of the supplemental oxygen from oxygen source 24 is provided at a flow rate substantially equal to the calculated oxygen concentration setpoint. In order to enhance the precision of the combination of the supplemental oxygen with the breathable gas, regulator processor 60 may control oxygen control valve 50 in a feedback loop, that implements the flow rate measured by second flow sensor 52, to correct for discrepancies between the calculated oxygen flow rate setpoint and the measured flow rate.

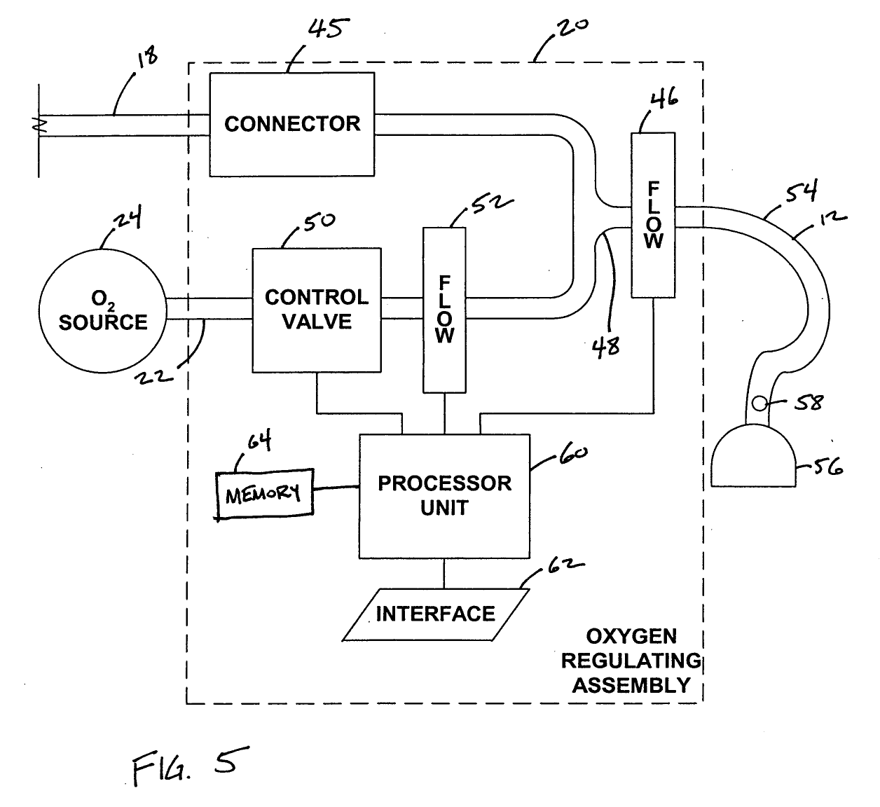

FIG. 5 schematically illustrates an alternate configuration of oxygen regulator assembly 20′, according to one embodiment of the invention. In the embodiment of FIG. 5, first flow sensor 46′ is disposed downstream from junction 48, and measures a flow rate of the oxygenated gas that includes the pressurized flow of breathable gas generated by gas delivery system 16 and the supplemental oxygen provided by oxygen regulator assembly 20. Although this relocation of first flow sensor 46 may not substantially alter the basic mode of operation of oxygen regulator assembly 20, the equation for determining the oxygen flow rate set point becomes:

$${Q}_{app} = {Q}_{gas} ( \frac{{Φ}_{set} - {Φ}_{bg}}{1 - {Φ}_{bg}} ) , \qquad ( 2 )$$

where Q_{gas} is the flow rate of the oxygenated gas as measured by first flow sensor 46′.

It should be appreciated that the configurations of flow sensors 46 and 52 shown in FIGS. 4 and 5 are not comprehensive and that other configurations may be implemented. For example, in one embodiment, flow sensors are disposed to measure a flow rate of the flow of pressurized breathable gas 18 and a flow rate of the oxygenated gas 12, and processor 60 controls control valve 50 based on these measurements. In another embodiment, flow sensors are disposed to measure a flow rate for each of the flow of pressurized breathable gas 18, the supplemental oxygen 22, and the oxygenated gas 12, and processor 60 controls control valve 50 based on these measured flow rates.

Because delivery system processor 40 of gas delivery system 16 controls the generation of the pressurized flow of breathable gas in a feedback manner based on pressure, and regulator processor 60 of oxygen regulator assembly 20 controls the supplemental oxygen based on measured flow rates, delivery system processor 40 and regulator processor 60 may operate independently without substantial communication therebetween. In other words, because control of the generation of the pressurized flow of breathable gas by gas delivery system 16 is based on pressure, the addition of supplemental oxygen into the system 10 by oxygen regulator assembly 20 will be detected by pressure sensor 36 as an increase in pressure, and the flow rate of the pressurized gas will automatically be adjusted accordingly so that the pressure of the total gas (oxygenated gas) delivered to the patient will be substantially unchanged by the added supplemental oxygen, even in embodiments in which delivery system processor 40 and regulator processor 60 are not operatively linked for communication of control, or other, signals. Similarly, changes in the flow rate of the pressurized flow of breathable gas made by gas delivery system 16 to hold the pressure of the gas delivered to the patient at a desired level will be detected by regulator processor 60 via first flow sensor 46, and may be accounted for by automatically adjusting the flow of supplemental oxygen in accordance with the detected change to maintain the oxygen concentration level of the oxygenated gas.

Although the processors 40 and 60 need not be in communication with each other in order for patient treatment system 10 to operate properly in accordance with the invention, an estimate by delivery system processor 40 (and subsequent reports to a user) with respect to the flow rate. and/or volume of the gas delivered to the patient in an embodiment in which processors 40 and 60 are not operatively linked may be somewhat less accurate because the estimate would not take into account the addition of the supplemental oxygen downstream from the gas delivery system 16. In one embodiment in which processors 40 and 60 are not operatively linked, oxygen regulator assembly 20 includes a visible indication on a housing associated therewith that the implementation of oxygen regulator assembly 20 with gas delivery system 16 will substantially affect estimates of flow rate and/or volume obtained from gas delivery system 16. The visible indication may include, for example, a pictorial representation, a written statement, or other visible indication. In another embodiment, oxygen regulator assembly 20 includes a similar visible indication and provides accurate estimates of the flow rate and/or volume of gas delivered to the patient via the regulator control interface 62.

Of course, while processor modules 40 and 60 need not be operatively linked for communication, in some embodiments, gas delivery system 16 and oxygen regulator assembly 20 may be in communication with each other, and may communicate various information regarding the generation of the flow of pressurized flow of breathable gas and/or the flow of the supplemental oxygen. For example, oxygen regulator assembly 20 may communicate the flow rate of the supplemental oxygen to gas delivery system 16 so that delivery system processor 40 can account for the supplemental oxygen in performing leak estimations, and/or for adjusting estimates with regard to the flow rate and/or volume of gas delivered to the patient.

It should be appreciated that the embodiments of oxygen regulator assembly 20 illustrated in FIGS. 4 and 5 are not intended to be exhaustive, and that any configuration of components that enable a modular assembly to be connected to a system similar to gas delivery system 16, downstream from the system, to elevate the oxygen concentration level of the flow of gas generated by the system to a selectably configurable level would fall within the scope of the invention. For example, oxygen regulator assembly 20 may be a self-contained unit that can be connected with other gas delivery systems. The oxygen regulator assembly 20, in one embodiment, has its own housing that contains the oxygen regulator valve 50 and the regulator processor 60. The housing may also include, in a non-limiting example, the memory 64, interface 62, flow sensor 52, flow sensor 46, and/or connector 45. In addition, the gas delivery system 16, in one exemplary embodiment, includes a housing in which the pressure generator 26 and delivery system processor 40 are disposed. The gas delivery system housing may also contain the flow sensor 38, pressure sensor 36, and/or interface 42. The housing may also include memory 44 and/or control valve 32. Further, although patient treatment system 10 has been described above as including oxygen regulator assembly 20 for regulating an oxygen concentration level of gas delivered to a patient, the invention contemplates substituting oxygen with another gaseous composition.

It should also be understood that while the present invention has been described above as delivering oxygen as the supplemental gas to the patient concurrently with the primary gas flow, other gas can be used as the supplemental gas. For example, it is known to deliver helium, a helium-oxygen mixture (heliox), nitrogen, a nitrogen-oxygen mixture (nitrox), a helium-oxygen-nitrogen mixture (trimix), or any other gas or combination of gasses to a patient. These gasses or combination of gasses can be used as supplemental gas 22 that is combined with the primary gas flow. The descriptions given above for setting the gas concentration levels of the supplemental are applicable for these other types of gas or gas mixtures, and the hardware remains the same. The main difference being that gas source 24 is not an oxygen source, but the source for the other gas or gas mixture being introduced to the patient.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A modular gas regulator assembly that selectively controls a gas concentration delivered to a patient by controlling a flow of a supplemental gas that is delivered to the patient concomitantly with a pressurized flow of breathable gas generated by a gas delivery system, the gas delivery system being controlled by a delivery system processor, the modular gas regulator assembly comprising:
a control interface that enables selection of a concentration level setpoint for the supplemental gas;
a gas flow regulator that regulates a flow rate of the supplemental gas from a gas source; and
a regulator processor that controls the gas flow regulator such that the supplemental gas from the gas source and the pressurized flow of breathable gas delivered to the patient have a gas concentration level that is substantially equal to the gas concentration level setpoint, the regulator processor being independent from the delivery system processor.

2. The modular gas regulator assembly of claim 1, wherein the supplemental gas and the pressurized flow of breathable gas are delivered to the patient via a common path.

3. The modular gas regulating module of claim 1, wherein the regulator processor controls the gas flow regulator by determining a gas flow rate setpoint of the supplemental gas based in part on the gas concentration level setpoint, and controlling the gas flow regulator to regulate the flow rate of the supplemental gas such that the flow rate of the supplemental gas is substantially equal to the gas flow rate setpoint of the supplemental gas, the determination of the gas flow rate setpoint of the supplemental gas being made by the regulator processor independent from the delivery system processor.

4. The modular gas regulator assembly of claim 3, further comprising a first flow sensor in operative communication with the regulator processor, wherein the first flow sensor measures a flow rate of the pressurized flow of breathable gas, wherein the regulator processor determines the gas flow rate setpoint of the supplemental gas based in part on the gas concentration level setpoint and the flow rate of the pressurized flow of breathable gas.

5. The modular gas regulator assembly of claim 4, wherein the first flow sensor is a component of the gas delivery system, the regulator processor being operatively linked with the gas delivery system to receive information from the first flow sensor associated with the flow rate of the pressurized flow of breathable gas.

6. The modular gas regulator assembly of claim 4, wherein the regulator processor determines the gas flow rate setpoint of the supplemental gas based on the equation:
$${Q}_{app} = {Q}_{bg} ( \frac{{Φ}_{set} - {Φ}_{bg}}{1 - {Φ}_{set}} ) ,$$
wherein Qₐₚₚ is the gas flow rate setpoint, Q_{bg} is the measured flow rate of the breathable gas, Φ_{bg} is the gas concentration level of the breathable gas, and D,set is the gas concentration level setpoint.

7. The modular gas regulator assembly of claim 4, further comprising a second flow sensor in operative communication with the regulator processor that measures the flow rate of the supplemental gas from the as source, and wherein the regulator processor controls the gas flow regulator in a feedback manner based on the gas flow rate setpoint of the supplemental gas and the flow rate of the supplemental gas as measured by the second flow sensor.

8. The modular gas regulator assembly of claim 3, wherein the supplemental gas and the pressurized flow of breathable gas are delivered to the patient via a common path.

9. The modular gas regulator assembly of claim 8, further comprising a first flow sensor in operative communication with the regulator processor that measures a flow rate of the pressurized flow of breathable gas and the supplemental gas within the common path, wherein the regulator processor determines the gas flow rate setpoint of the supplemental gas based in part on the gas concentration level setpoint and the flow rate of the pressurized flow of breathable gas and the supplemental gas within the common path.

10. The modular gas regulator assembly of claim 9, wherein the regulator processor determines the gas flow rate setpoint of supplemental gas based on the equation:
$${Q}_{app} = {Q}_{gas} ( \frac{{Φ}_{set} - {Φ}_{bg}}{1 - {Φ}_{bg}} ) ,$$
wherein Qₐₚₚ is the gas flow rate setpoint, Q_{gas} is the measured flow rate of the pressurized flow of breathable gas and the supplemental gas within the common path, Φ_{bg} is the gas concentration level of the breathable gas, and Φₛₑₜ is the gas concentration level setpoint.

11. The modular gas regulator assembly of claim 10, further comprising a second flow sensor in operative communication with the regulator processor that measures the actual flow rate of the supplemental gas from the gas source, and wherein the regulator processor controls the gas flow regulator in a feedback manner based on the gas flow rate setpoint of the supplemental gas and the actual flow rate of the supplemental gas as measured by the second flow sensor.

12. The modular gas regulator assembly of claim 1, wherein the regulator processor communicates information to the delivery system processor, the information being related to the combination of the pressurized flow of gas with gas from the gas source.

13. The modular gas regulator assembly of claim 1, wherein the gas flow regulator includes a valve that is controllable via the regulator processor.

14. The modular gas regular assembly of claim 1, wherein the supplemental gas is oxygen, helium, nitrogen, or any combination thereof.

15. A patient treatment system comprising:
a gas delivery system that generates a pressurized flow of breathable gas for delivery to a patient;
a delivery system processor associated with the gas delivery system that controls the gas delivery system in generating the pressurized flow of breathable gas;
a modular gas regulator assembly that regulates a flow of supplemental gas from a gas source, the supplemental gas being delivered to the patient concomitant with the pressurized flow of breathable gas to selectively control an gas concentration level of the supplemental gas and the pressurized flow of breathable gas delivered to the patient concomitantly; and
a regulator processor associated with the modular gas regulator assembly that regulates the flow of the supplemental gas, the regulator processor being independent from the delivery system processor.

16. The patient treatment system of claim 15, wherein the delivery system processor controls the gas delivery system to generate the pressurized flow of breathable gas such that the pressurized flow of breathable gas has (1) a substantially constant pressure, or (2) a bi-level pressure level in which a pressure varies between inspiration and expiration.

17. The patient treatment system of claim 15, wherein the modular gas regulator assembly includes a valve that is controllable via the regulator processor to regulate the flow rate of the supplemental gas from the gas source.

18. The patient treatment system of claim 15, wherein the supplemental gas and the pressurized flow of breathable gas are delivered to the patient via a common path.

19. The patient treatment system of claim 15, further comprising a control interface associated with the modular gas regulator assembly that enables selection of an gas concentration level setpoint, wherein the regulator processor controls the regulation of the flow of the supplemental gas such that the gas concentration level of the pressurized flow of breathable gas and the supplemental gas delivered to the patient concomitantly is substantially equal to the gas concentration level setpoint.

20. The patient treatment system of claim 15, wherein the regulator processor communicates information to the delivery system processor, the information being related to the flow of the supplemental gas.

21. The patient treatment system of claim 15, wherein the supplemental gas is oxygen, helium, nitrogen, or any combination thereof.

22. A patient treatment system comprising:
a first housing;
a pressure generator contained within the first housing that generates a pressurized flow of breathable gas for delivery to a patient;
a first processor contained within the first housing that controls the pressure generator;
a second housing independent from the first housing;
a gas flow regulator contained in the second housing that regulates a flow rate of supplemental gas from a gas supply for delivery to the patient concomitantly with the pressurized flow of breathable gas; and
a second processor contained within the second housing that controls the gas flow regulator.

23. The patient treatment system of claim 22, wherein said second housing further contains a first flow sensor, a second flow sensor, and a regulator control interface.

24. The patient treatment system of claim 22, wherein said first housing further contains a control valve, a flow sensor, and a delivery system control interface.

25. The patient treatment system of claim 22, wherein the supplemental gas is oxygen, helium, nitrogen, or any combination thereof.
